(19) United States
(12) Patent Application Publication
(10) Pub. No.: US 2008/0156430 A1
(43) Pub. Date: Jul. 3, 2008

(54) Apparatus and method for mounting silicon ingot to mounter

(75) Inventor: Yong-Joon Jo, Gumi-si (KR)

Correspondence Address: GREER, BURNS & CRAIN, 300 S WACKER DR, 25TH FLOOR, CHICAGO, IL, 60606, US

(73) Assignee: SILTRON INC.

(21) Appl. No.: 12/001,496

(22) Filed: Dec. 11, 2007

(30) Foreign Application Priority Data
Dec. 29, 2006 (KR) 10-2006-0138662

(51) Int. Cl. B29C 65/14

(52) U.S. Cl. 156/275.5; 156/380.9; 156/60

(57) ABSTRACT

The present invention relates to apparatus and method for a silicon ingot to a mounter, the apparatus including a frame; a mounter placed on the frame for mounting a silicon ingot; a press member installed movably to the frame for pressing the silicon ingot toward the mounter; and a heat or light emitting member arranged to emit heat or light to an adhesive member interposed between the silicon ingot and the mounter.

### BACKGROUND OF THE INVENTION

1. Field of the Invention

The present invention relates to apparatus and method for mounting a silicon ingot to a mounter, and in particular, to improved apparatus and method for mounting a silicon ingot to a mounter, which, before cutting the silicon ingot into wafers, attach the silicon ingot to the mounter using an adhesive and then dry the adhesive.

2. Description of the Related Art

Generally, to manufacture a silicon ingot into individual wafers, a growth-completed silicon ingot is cut into individual wafers through a slicing operation. This cutting process cuts the silicon ingot into a plurality of wafers simultaneously, and is performed by a method using a piano wire or a high tension wire, i.e. a so-called wire saw (W.S) method. However, to cut the silicon ingot, the ingot should be fixed to a specific jig, which is referred to as an ingot mounting process.

Referring to FIG. 1 illustrating schematically a conventional ingot mounting process, in the ingot mounting process, a mounter beam 1 is attached to an operating plate 3 using an organic bond 7 such as an epoxy, a silicon ingot 5 is attached to the mounter beam 1 using a different kind of epoxy bond 9, and the bonds 7 and 9 are cured for about 8 hours in an industrial space where temperature and humidity are uniformly managed, so that the silicon ingot 5, the mounter beam 1 and the operating plate 3 are attached to each other.

However, the conventional ingot mounting process dries the epoxy bond by so-called natural drying, and thus unnecessarily extends a lead time of the entire process for manufacturing wafers and disadvantageously requires an excessive standby space for drying.

The present invention is designed to solve the above-mentioned problem of the prior art, and therefore it is an object of the present invention to provide apparatus and method for mounting a silicon ingot to a mounter, which reduce the time required to adhere and dry an adhesive in a silicon ingot mounting process.

### SUMMARY OF THE INVENTION

In order to achieve the above-mentioned objects, the present invention provides an apparatus for mounting a silicon ingot to a mounter including a frame; a mounter placed on the frame for mounting a silicon ingot; a press member installed movably to the frame for pressing the silicon ingot toward the mounter; and a heat or light emitting member arranged to emit heat or light to an adhesive member interposed between the silicon ingot and the mounter.

The apparatus for mounting a silicon ingot to a mounter according to a preferred embodiment further includes a reflecting member installed at a side of the heat or light emitting member for concentrating the heat or light emitted from the heat or light emitting member, to the adhesive member.

In the apparatus for mounting a silicon ingot to a mounter according to a preferred embodiment, the heat or light emitting member has a heat transfer coil heater or an infrared lamp.

In the apparatus for mounting a silicon ingot to a mounter according to a preferred embodiment, the heat transfer coil heater or infrared lamp is provided in a pair, each of the pair being arranged at both sides of the silicon ingot in a lengthwise direction of the silicon ingot.

In the apparatus for mounting a silicon ingot to a mounter according to a preferred embodiment, the heat or light emitting member is located less than about 100 mm from an edge of the adhesive member.

In the apparatus for mounting a silicon ingot to a mounter according to a preferred embodiment, the mounter includes a mounter beam having a first surface contacted with the silicon ingot, and an operating plate contacted with a second surface of the mounter beam opposite to the first surface, the mounter further includes a second adhesive member adhered to the second surface, and the heat or light emitting member may emit heat or light to both of the adhesive member and the second adhesive member.

In order to achieve the above-mentioned objects, the present invention also provides a method for mounting a silicon ingot to a mounter, including (a) interposing an adhesive member between a silicon ingot and a mounter; and (b) emitting heat or light to the adhesive member for a predetermined time using a heat or light emitting member.

Preferably, the step (b) further includes a step of concentrating the heat or light, emitted from the heat or light emitting member, to the adhesive member.

Preferably, the step (b) emits the heat or light using a heat transfer coil heater or an infrared lamp.

Preferably, the step (b) simultaneously emits the heat or light to both sides of the adhesive member using the heat or light emitting member that is provided in a pair, each of the pair being arranged at both sides of the silicon ingot in a lengthwise direction of the silicon ingot.

Preferably, the mounter includes a mounter beam having a first surface contacted with the silicon ingot and an operating plate contacted with a second surface of the mounter beam opposite to the first surface, the step (a) further includes a step of adhering a second adhesive member to the second surface of the mounter beam, and the step (b) emits the heat or light of the heat or light emitting member to both of the adhesive member and the second adhesive member.

### BRIEF DESCRIPTION OF THE DRAWINGS

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

FIG. 1 is a schematic view of a conventional process for mounting a silicon ingot to a mounter.

FIG. 2 is a schematic view of an apparatus for mounting a silicon ingot to a mounter according to a preferred embodiment of the present invention.

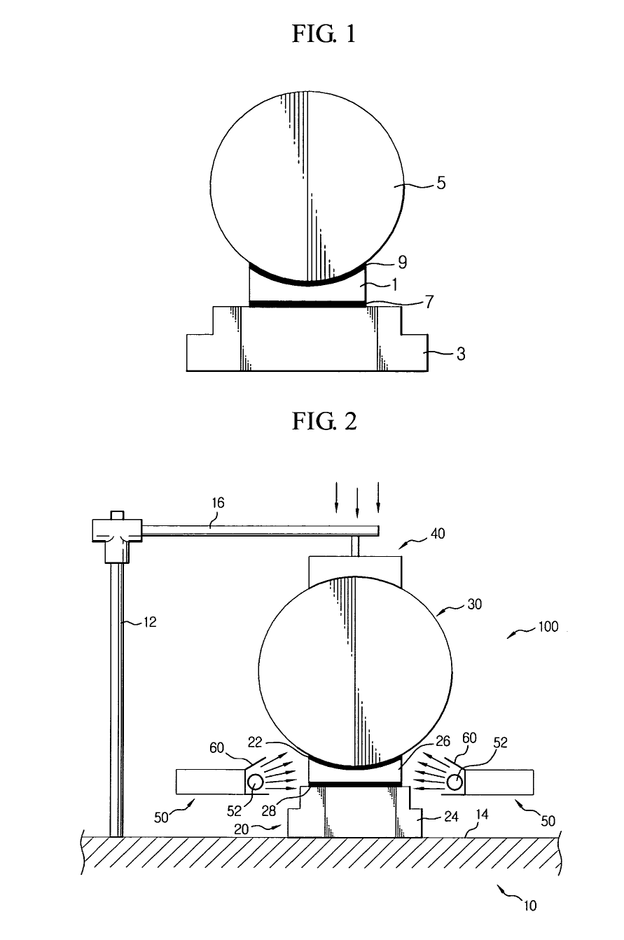

### DESCRIPTION OF THE PREFERRED EMBODIMENT

Hereinafter, preferred embodiments of the present invention will be described in detail with reference to the accompanying drawings.

FIG. 2 is a schematic view of an apparatus for mounting a silicon ingot to a mounter according to a preferred embodiment of the present invention.

Referring to FIG. 2, the apparatus 100 for mounting a silicon ingot according to an embodiment includes a frame 10, a mounter 20 placed on the frame 10, a press member 40 installed movably to a support 12 provided on the frame 10 for pressing a silicon ingot 30 toward the mounter 20, a heat or light emitting member 50 for emitting heat or light to an adhesive member 22 interposed between the silicon ingot 30 and the mounter 20, and a reflecting member 60 installed near the heat or light emitting member 50 for concentrating the heat or light, emitted from the heat or light emitting member 50, to the adhesive member 22.

The frame 10 includes a flat bottom surface 14, the support 12 installed substantially perpendicular to the bottom surface 14, and an extension rod 16 installed movably along the support 12, and the press member 40 is installed to the extension rod 16 for pressing an upper portion of the silicon ingot 30 in a downward direction.

The mounter 20 is fixed on the bottom surface 14. The mounter 20 serves as a jig of a predetermined shape that will be installed to a feed (not shown) of a cutting device of a mounting ingot. If only the mounter 20 has a concave surface corresponding to a rounded surface of the silicon ingot 30, the mounter 20 is not limited to a specific jig. However, in this embodiment, the mounter 20 includes an operating plate 24 made of metal and contacted with the bottom surface 14, and a mounter beam 26 adhered to an upper surface of the operating plate 24 and having a rounded concave surface of a predetermined shape and capable of supporting the silicon ingot 30.

Each of the operating plate 24 and the mounter beam 26 is located parallel with a lengthwise direction of the silicon ingot 30. The operating plate 24 and the mounter beam 26 are adhered to each other by a second adhesive member 28 such as an epoxy bond. The mounter beam 26 and the silicon ingot 30 are adhered to each other by the adhesive member 22. It is preferable to use the second adhesive member 28 of different kind from the adhesive member 22. This is for obtaining good adhesive strength according to characteristics of materials adhered to each other.

Preferably, the adhesive members 22 and 28 use a typical organic bond such as an epoxy bond, and it is preferable to use the adhesive members 22 and 28 of different materials.

The heat or light emitting member 50 is configured to reduce a curing time of the adhesive members 22 and 28. Preferably, the heat or light emitting member 50 emits heat or light partially to only a portion applied with the adhesive members 22 and 28, rather than emits heat or light in the whole similarly to a heater made of a metal coil material, to increase only temperature of the portion applied with the adhesive members 22 and 28, thereby reducing a drying time. For this purpose, preferably the heat or light emitting member 50 has a lamp structure. To cure the adhesive members 22 and 28, a halogen lamp may be considered, but is mainly used to increase a temperature of liquid, and thus, because the adhesive members 22 and 28 used in this embodiment mainly exist in solid or gel state, it is preferable to use a heat transfer coil heater or an infrared lamp 52.

As the heat or light emitting member 50, it is effective to form a pair of heat or light emitting members arranged at both sides of the silicon ingot 30 along a lengthwise direction of the silicon ingot 30. And, preferably the heat or light emitting member 50 is located less than about 100 mm from the edges of the adhesive members 22 and 28.

The reflecting member 60 is formed of a reflecting plate. The reflecting member 60 reflects the heat or light in a uniform direction that is emitted from the heat transfer coil heater or infrared lamp 52 of the heat or light emitting member 50, so that the heat or light is concentrated toward the adhesive members 22 and 28.

A method for mounting the silicon ingot to the mounter according to a preferred embodiment of the present invention is described as follows.

The method for mounting the silicon ingot to the mounter according to an embodiment includes a first step of adhering the mounter 20 of a predetermined shape in a lengthwise direction of the silicon ingot 30 using the adhesive member 22; and a second step of emitting heat or light to the adhesive member 22 for a predetermined time using the heat or light emitting member 50 to dry the adhesive member 22.

The first step may be divided into a step of adhering the mounter beam 26 to the operating plate 24 using the second adhesive member 28, and a step of adhering the silicon ingot 30 to the mounter beam 26 using the adhesive member 22 that is different from the second adhesive member 28.

The second step includes a step of emitting heat or light of the heat or light emitting member 50 to both of the adhesive members 22 and 28. And, preferably the second step emits the heat or light of the heat or light emitting member 50 at both sides of the adhesive members 22 and 28 to reduce a drying time of the adhesive members 22 and 28, thereby improving a heat efficiency.

Meanwhile, the second step further includes a step of installing the reflecting member 60 at an end of the heat or light emitting member 50 to concentrate the heat or light, emitted from the heat or light emitting member 50, toward the adhesive members 22 and 28.

It should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

The present invention uses a heat transfer coil heat or infrared lamp to dry an adhesive member, and thus reduces 8 hour mounting operation time required by a conventional natural drying method to about 20 minutes.

And, the present invention reduces a standby time to improve a lead time of a process and a space efficiency.

What is claimed is:

1. An apparatus for mounting a silicon ingot to a mounter, comprising:
a frame;
a mounter placed on the frame for mounting a silicon ingot thereto;
a press member installed movably to the frame for pressing the silicon ingot toward the mounter; and
a heat or light emitting member arranged to emit heat or light to an adhesive member interposed between the silicon ingot and the mounter.

2. The apparatus for mounting a silicon ingot to a mounter according to claim 1, further comprising:
a reflecting member installed at a side of the heat or light emitting member for concentrating the heat or light, emitted from the heat or light emitting member, to the adhesive member.

3. The apparatus for mounting a silicon ingot to a mounter according to claim 2,
wherein the heat or light emitting member has a heat transfer coil type heater or an infrared lamp.

4. The apparatus for mounting a silicon ingot to a mounter according to claim 3,
wherein the heat transfer coil heater or infrared lamp is provided in a pair, each of the pair being arranged at both sides of the silicon ingot in a lengthwise direction of the silicon ingot.

5. The apparatus for mounting a silicon ingot to a mounter according to claim 2,
wherein the mounter includes a mounter beam having a first surface contacted with the silicon ingot, and an operating plate contacted with a second surface of the mounter beam opposite to the first surface,
wherein the mounter further includes a second adhesive member adhered to the second surface, and
wherein the heat or light emitting member emits the heat or light to both of the adhesive member and the second adhesive member.

6. The apparatus for mounting a silicon ingot to a mounter according to claim 1,
wherein the heat or light emitting member has a heat transfer coil type heater or an infrared lamp.

7. The apparatus for mounting a silicon ingot to a mounter according to claim 6,
wherein the heat transfer coil heater or infrared lamp is provided in a pair, each of the pair being arranged at both sides of the silicon ingot in a lengthwise direction of the silicon ingot.

8. The apparatus for mounting a silicon ingot to a mounter according to claim 1,
wherein the heat transfer coil heater or infrared lamp is provided in a pair, each of the pair being arranged at both sides of the silicon ingot in a lengthwise direction of the silicon ingot.

9. A method for mounting a silicon ingot to a mounter, comprising:
(a) interposing an adhesive member between a silicon ingot and a mounter; and
(b) emitting heat or light to the adhesive member for a predetermined time using a heat or light emitting member.

10. The method for mounting a silicon ingot to a mounter according to claim 9,
wherein the step (b) further includes a step of concentrating the heat or light, emitted from the heat or light emitting member, to the adhesive member.

11. The method for mounting a silicon ingot to a mounter according to claim 10,
wherein the step (b) emits that heat or light using a heat transfer coil heater or an infrared lamp.

12. The method for mounting a silicon ingot to a mounter according to claim 10,
wherein the step (b) simultaneously emits the heat or light to both sides of the adhesive member using the heat or light emitting member provided in a pair, each of the pair being arranged at both sides of the silicon ingot in a lengthwise direction of the silicon ingot.

13. The method for mounting a silicon ingot to a mounter according to claim 10,
wherein the mounter includes a mounter beam having a first surface contacted with the silicon ingot and an operating plate contacted with a second surface of the mounter beam opposite to the first surface,
where the step (a) further includes a step of adhering a second adhesive member to the second surface of the mounter beam, and
where the step (b) emits the heat or light of the heat or light emitting member to both of the adhesive member and the second adhesive member.

14. The method for mounting a silicon ingot to a mounter according to claim 9,
wherein the step (b) emits that heat or light using a heat transfer coil heater or an infrared lamp.

15. The method for mounting a silicon ingot to a mounter according to claim 9,
wherein the step (b) simultaneously emits the heat or light to both sides of the adhesive member using the heat or light emitting member provided in a pair, each of the pair being arranged at both sides of the silicon ingot in a lengthwise direction of the silicon ingot.

16. The method for mounting a silicon ingot to a mounter according to claim 9,
wherein the mounter includes a mounter beam having a first surface contacted with the silicon ingot and an operating plate contacted with a second surface of the mounter beam opposite to the first surface,
where the step (a) further includes a step of adhering a second adhesive member to the second surface of the mounter beam, and
where the step (b) emits the heat or light of the heat or light emitting member to both of the adhesive member and the second adhesive member.
